(19) United States
(12) Patent Application Publication
(10) Pub. No.: US 2026/0149648 A1
(43) Pub. Date: May 28, 2026

(54) MONITORING FOR A FAULT POINT OF A SERVICE USING A STATE MAP

(71) Applicant: Dell Products L.P., Round Rock, TX (US)

(72) Inventors: PARMESHWR PRASAD, Bangalore (IN); RAVISHANKAR KANAKAPURA N, Bangalore (IN); SHRINIDHI KATTE, Bangalore (IN)

(21) Appl. No.: 18/962,689

(22) Filed: Nov. 27, 2024

(51) Int. Cl. H04L 41/5025; H04L 41/5041

(52) U.S. Cl. CPC H04L 41/5025; H04L 41/5048

(57) ABSTRACT

Methods and systems for managing operation of a deployment are disclosed. The operation may be managed by writing a quality of performance of at least one operation of a service for at least one period of time to a state map. The quality of performance may include an index of the performance. If the at least one operation behaves normally, a value of the index of the performance may include 1, True, etc. Otherwise, if the at least one operation includes at least one failure, the value of the index of the performance may include 0, False, etc. The state map and at least one log of the at least one operation may be used to generate a remediation plan for the service.

### FIELD

Embodiments disclosed herein relate generally to managing operation of a deployment. More particularly, embodiments disclosed herein relate to monitoring performance of a service of the deployment.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2C show data flow diagrams illustrating operation of a system in accordance with an embodiment.

FIG. 3 shows a flow diagram illustrating at least one method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to managing operation of a deployment. The operation may be managed by monitoring for a fault point of a service of a data processing system of the deployment. The fault point may be monitored by writing an index of the performance of at least one operation of the service to a state map.

The state map may be a data structure that maintains a record, for at least one operation of the service and/or for at least one period of time, of a quality of performance. The quality of the performance may be denoted by the index of the performance. The quality of the performance may include a normal behavior, at least one failure, etc. of the at least one operation. For example, if the at least one behavior, for the at least one operation of the service and/or for the at least one period of time, includes the normal behavior, then the index of the performance may be written with a value of 1, True, etc. Otherwise, if the at least one behavior includes the at least one failure, then the index of the performance may be written with a value of 0, False, etc.

After the at least one failure occurs, the state map may be used with at least one log of the at least one operation to generate a remediation plan. To generate the remediation plan, the state map may be used by pinpointing at least one logical source of the at least one failure. The at least one logical source may include the at least one operation at the at least one period of the time. Further, the at least one log may be used by identifying a context of the at least one failure. Identifying the context may include reading at least one statement (e.g., informational, debug, error, warning, etc.) of the at least one log. Using the at least one statement, a remediation plan may be generated. The remediation plan may include (i) restarting the service, (ii) reverting code of the at least one operation to a stable version, (iii) applying at least one patch to the at least one operation, etc.

In an embodiment, a method for managing operation of a deployment is disclosed. The method may include: (i) identifying an occurrence of an issue impacting an ability of the deployment to provide computer implemented services, (ii) obtaining, based on the identifying, at least one log of operation of a service hosted by the deployment that contributes to the computer implemented services, (iii) obtaining a state map for the service that indicates operational states of functionalities of the service over time, (iv) obtaining a remediation plan based on the at least one log and the state map, (v) performing the remediation plan to update operation of the deployment to obtain an updated deployment, and (vi) providing the computer implemented services using the updated deployment.

The state map may include part of a state definition for a service.

The state definition may include (i) an identifier of the service, (ii) a functionality definition for the service, (iii) the state map, and (iv) a backup of the state map.

The functionality definition may indicate whether each function of the service is operable or inoperable.

The functionality definition may be usable to define portions of the state map at different points in time.

Each of the portions of the state map may correspond to different points in time, and each of the portions may include (i) a listing of indications of operability of functions of the service, and (ii) an indication of a corresponding one of the different points in time.

Obtaining the remediation plan may include (i) identifying a point in time using the at least one log and (ii) identifying a portion of the state map based on the point in time.

The portion of the state map may indicate operability of functions of the service during the point in time.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

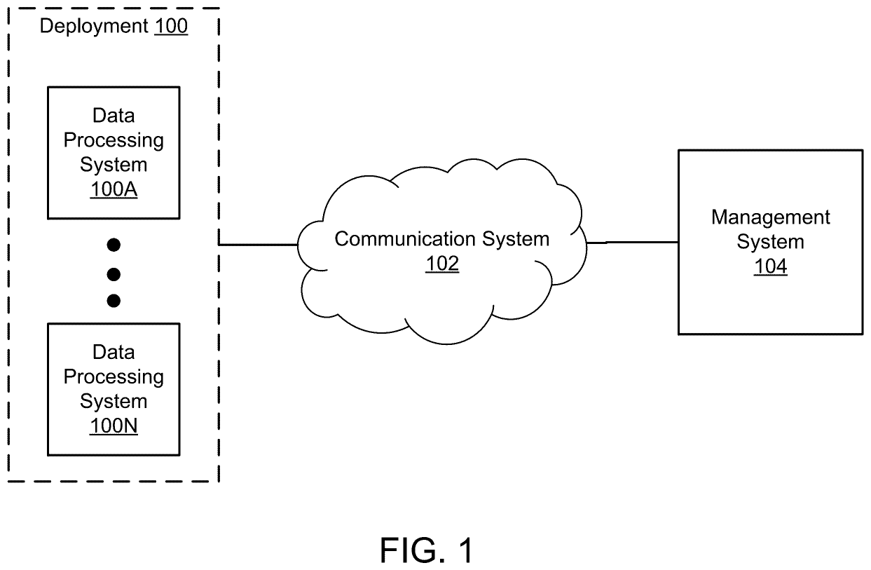

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, at least one service may be performed by a data processing system. The at least one service may be performed by performing at least one operation. The at least one operation may include a function call, a network request, a database transaction, an application programming interaction (API) interaction, a file read and/or write, etc.

The data processing system may monitor the at least one operation for at least one error and for at least one success. The data processing system may monitor the at least one operation by tracking for a fault point of the at least one operation. If the at least one error is found, the data processing system may record the at least one error in a log. The log may be used by, for example, an administrator, logging framework, etc. to find an underlying issue in the at least one operation.

However, an abundance of logs may be generated by the data processing system. Computer resources may therefore be more focused on pinpointing the at least one error in the abundance of the logs rather than on performing the at least one service. As a result, provision of the computer implemented services may be impacted.

In general, embodiments disclosed here relate to systems and methods for managing operation of a deployment. The operation may be managed by (i) generating a state map of a service and (ii) using the state map of the service to generate a remediation plan when at least one error is found in performance of at least one operation of the service.

The state map of the service may be generated by writing, by a data processing system, the state map to a state definition. The state definition may be stored in at least one database of a second data processing system, a management system, etc. The state definition may include (i) an identifier of the service, (ii) a functionality definition for the service, (iii) the state map, (iv) a backup of the state map, etc. The identifier may include a unique identification string (e.g., a number, an alphanumeric code, etc.). The functionality definition may include (i) an enumeration of at least one operation of the service, (ii) dependencies of the service, (iii) an input and/or an output for the at least one operation, (iv) a globally unique identifier (GUID) for an instance of the service, etc. The enumeration of the at least one operation may include (i) a description of the at least one operation to be performed, (ii) an index for a performance, which describes a performance state of the at least one operation (e.g., normal operation, failure, etc.), using, for example, a Boolean value (e.g., 0, 1, False, True, etc.), etc.

The state map may be used to record, by the data processing system, the index of the performance of the at least one operation of the service. The index of the performance of the at least one operation may be recorded for at least one period in time. The index of the performance may be generated by performing at least one computation with a performance metric from the at least one operation. The performance metric may include data output, response time, success rate, throughput, resource utilization, etc. of the at least one operation. At least one index of the performance may be included on the state map. The state map may include, for example, (i) a table with at least one column for each of the at least one operation, (ii) at least one row for each of the at least one period in time, and/or (iii) the index of the performance written to a cell of the at least one row and/or the at least one column.

As an instance of the service, denoted by a GUID in the functionality definition, begins, a point in time may begin. As a second point in time ends, the at least one period in the time may elapse. When the at least one period in the time elapses, a pull (e.g., the data processing system makes a request of the service for a transmission of data) and/or a push (e.g., an event process of the service occurs in which the service transmits the data) may occur. The data may include a performance metric of the at least one operation.

The performance metric may be transmitted by reporting, by the service, the performance metric of the at least one operation for the period of the time. The at least one computation may be performed ingesting, by the computation, the performance metric to generate the index of the performance. The index of the performance may be transmitted to the state map by sending, using a communication protocol of the data processing system, the index of the performance of the at least one operation to the database and writing the index of the performance to the state map. The state map in the database may be updated with the index of the performance of the at least one operation.

At least a second update may occur to the state map with a second index of the performance. Indices of the performance of the state map may indicate normal behavior (e.g., True, 1, etc.) and/or at least one failure (e.g., False, 0, etc.) of the performance of the at least one operation of the service for the at least one period of the time.

The state map may be used to generate the remediation plan. The state map may be used by pinpointing at least one logical source of the at least one failure of the at least one operation within the at least one period of the time. Once the at least one logical source has been pinpointed, at least one log may be used to further pinpoint context of the at least one logical source of the at least one failure. The at least one log may be used by ingesting at least one statement (e.g., informational, debug, error, warning, etc.) of the log and identifying at least one action to restore functionality of the at least one operation of the service. The at least one action may include (i) restarting the service, (ii) reverting code of the at least one operation to a stable version, (iii) applying at least one patch to the at least one operation, (iv) increasing resources available to the at least one operation, (v) reconfiguring a network setting and/or path, (vi) clearing a cache to remove outdated data, (vii) performing, by at least one administrator, an intervention to directly address the at least one failure, etc.

To provide the above noted functionality, the system may include deployment 100, and management system 104. Each of these components is discussed below.

Deployment 100 may include any number of data processing system 100A-100N and may include at least one service that is used to provide computer implemented services. A service of the at least one service may be performed, by the data processing system (e.g., 100A-100N), by performing at least one operation. The at least one operation may include a function call, a network request, a database transaction, an application programming interaction (API) interaction, a file read and/or write, etc.

As an instance of the service, denoted by a GUID in the functionality definition, begins, a point in time may begin. As a second point in time ends, at least one period in the time may elapse. When the at least one period in the time elapses, a pull (e.g., data processing system (e.g., 100A-100N) makes a request of the service to transmit data) and/or a push (e.g., an event process of the service occurs in which the service transmits the data) may occur. The data may include a performance metric. The performance metric may be transmitted by reporting, by the service, the performance metric of the at least one operation for the period of the time.

At least one computation may be performed using the performance metric to generate an index of the performance. At least one computation may be performed by ingesting, by at least one function of the data processing system (e.g., 100A-100N), the performance metric to generate the at index of the performance. The index of the performance may be transmitted to the state map by sending, using a communication protocol the data processing system (e.g., 100A-100N), the index of the performance of the at least one operation to the database and writing the index of the performance to the state map. The state map in the database may be updated with the index of the performance of the at least one operation. The database may be stored on a management system (e.g., 104), the data processing system (e.g., 100A-100N), etc.

The management system (e.g., 104) may include the database in which the state map of the service is stored and/or a second database in which at least one log of the service is stored. During development of a remediation plan, the state map of the service and the at least one log of the service may be accessed by a logging framework, at least one administrator, etc. Using the logging framework, the at least one administrator, etc. at least one logical source of at least one error may be pinpointed, using the state map, within the at least one operation and/or within the at least one period of the time at which at least one failure occurred. Once the at least one logical source of the at least one error has been pinpointed, the at least one log may be used to further pinpoint context of the at least one failure. The at least one log may be used by ingesting at least one statement (e.g., informational, debug, error, warning, etc.) of the at least one log and determining an action, by management system 104, to restore functionality of the at least one operation of the service.

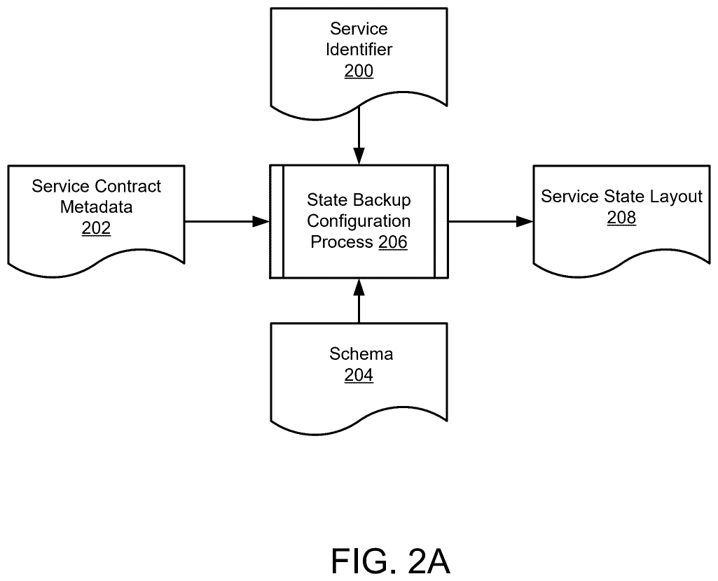

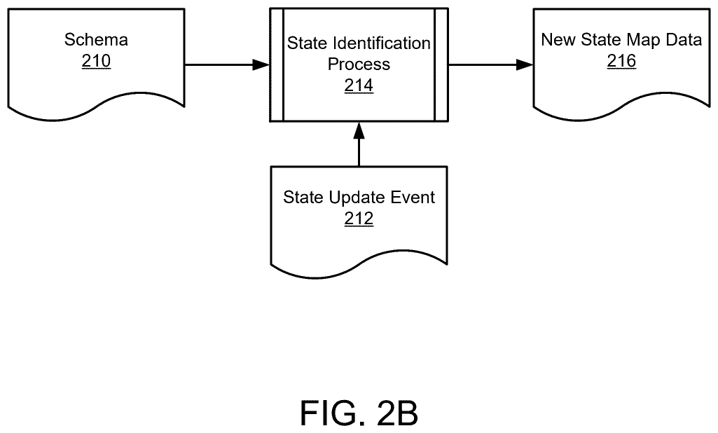

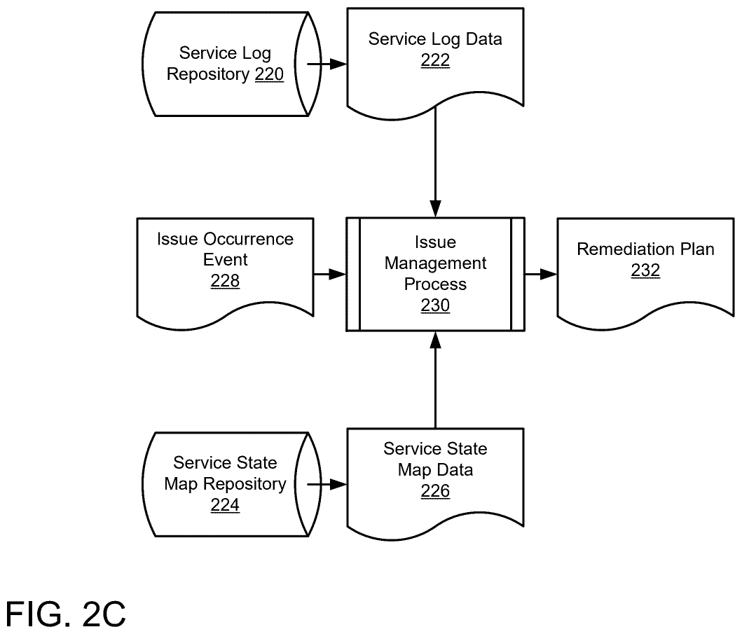

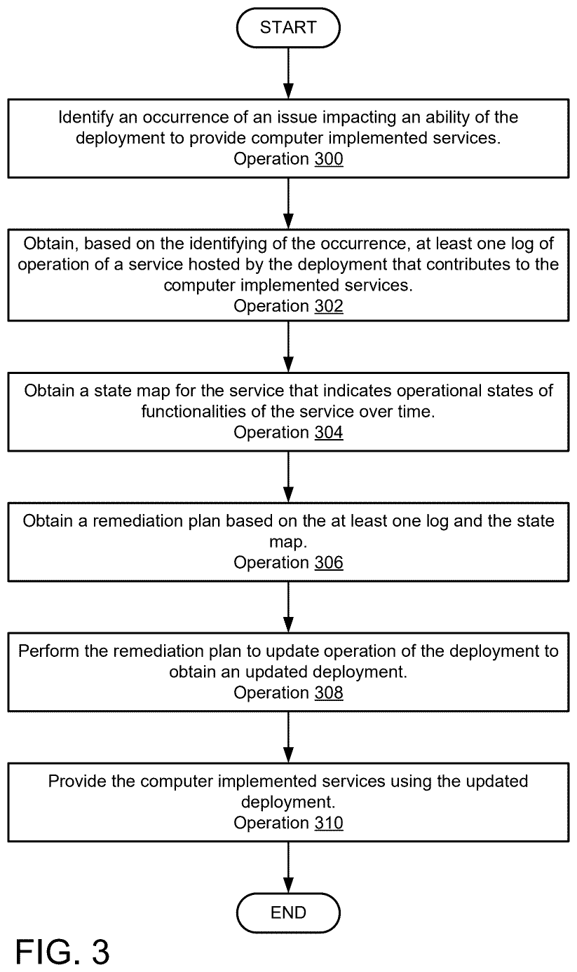

While providing their functionality, any of deployment 100 and management system 104 may perform all, or a portion, of the flows and methods shown in FIGS. 2A-3.

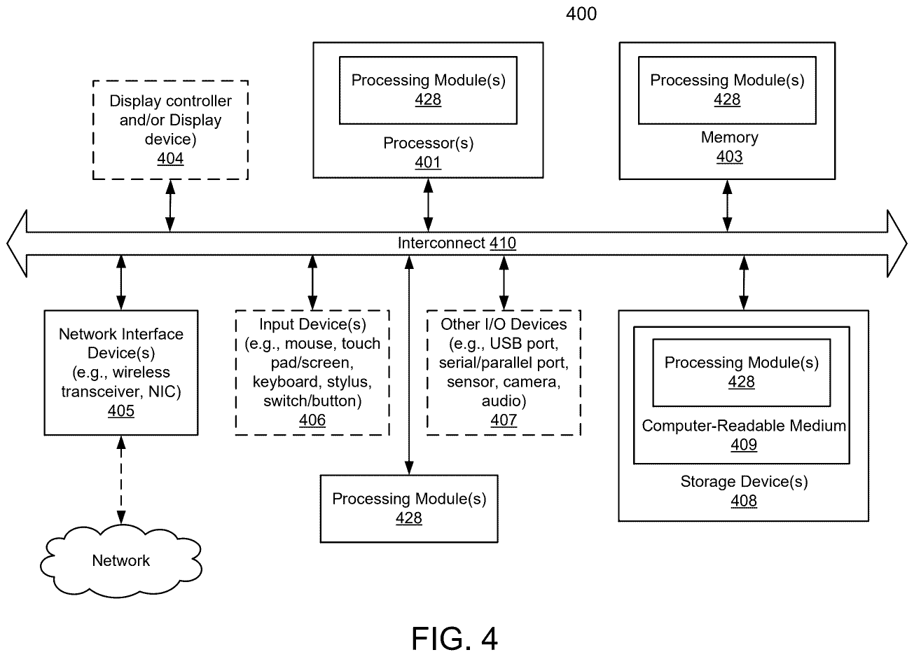

Any of (and/or components thereof) deployment 100 and management system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 200, 202, etc.) is used to represent data structures, a second set of shapes (e.g., 206, 214, etc.) is used to represent processes performed using and/or that generate data, and a third set of shapes (e.g., 220, 224, etc.) is used to represent large scale data structures such as databases.

Turning to FIG. 2A, a first data flow diagram in accordance with an embodiment is shown. The first data flow diagram may illustrate data used in and data processing performed in establishing a functionality definition.

To establish the functionality definition, state backup configuration process 206 may be performed. During state backup configuration process 206, a service identifier (e.g., 200), a service contract metadata (e.g., 202), and/or a schema (e.g., 204) may be ingested.

The service identifier (e.g., 200) may include a unique identification string (e.g., a number, an alphanumeric code, etc.). The unique identification string may identify a service. The service may be used to perform at least one operation. The at least one operation may include a function call, a network request, a database transaction, an application programming interaction (API) interaction, a file read and/or write, etc.

A service contract metadata (e.g., 202) may include (i) a globally unique identifier (GUID) for an instance of the service, (ii) identification of at least one dependency of the service, (iii) the identification of at least one input and at least one output of the service, etc.

The GUID may include, for example, a 128-bit number that is represented in hexadecimal format so that it is unique from the GUID of a second instance of the service. The at least one dependency of the service may include at least one application programming interface (API), at least one database, at least one library, at least one framework, at least one cloud service, at least one configuration file, at least one hardware device (e.g., a sensor, a printer, etc.), etc. The at least one input and the at least one output may include a second at least one API (e.g. the API may send data to and/or retrieve the data from the service), at least one user interface (e.g., the user interface may allow a user to interact directly with the service), a second at least one hardware device (e.g., a second sensor can ingest input the data from a physical area to provide to the service, a second printer may output the data from the service, etc.), etc.

A schema (e.g., 204) may include a structured representation of the service. The structured representation may identify (i) the service, (ii) at least one operation of the service, (iii) a destination service for at least one output data of the service, (iv) a version number of the service, etc. An enumeration of the at least one operation may include (i) a description of the at least one operation to be performed, (ii) an index for a performance order of the at least one operation, (iii) an output that includes an index of performance (e.g., success, failure, etc.) by the at least one operation which may be written, for example, using a Boolean value (e.g., 0, 1, False, True, etc.).

Once the service identifier (e.g., 200), the service contract metadata (e.g., 202), and/or the schema (e.g., 204) have be ingested during state backup configuration process 206, the functionality definition may be established. The functionality definition may be established by writing a service state layout (e.g. 208) to a database that is stored on a management system (e.g., 104), a data processing system (e.g., 100A, 100B, etc.), etc. On the service state layout (e.g., 108), first data from the service identifier (e.g., 200), second data of the service contract metadata (e.g., 202), and third data of the schema (e.g., 204) may be written.

At a top level, the first data of the service identifier (e.g. 200) and/or the GUID of the instance of the service may be written. In a first at least one child level, the second data of the service contract metadata (e.g., 202) and/or the third data of the schema (e.g., 204) may be written.

In a second at least one child level, at least one state map may be written. The at least one state map may be written, for example, in a data structure that includes an at least two-dimensional table. The at least two-dimensional table may include at least one column for each of the at least one operation and at least one row for each of an at least one period in time. A cell of the at least one column and the at least one row may store an index of performance of the at least one operation. The index of the performance may be stored, for example, as a Boolean value (e.g., 0, 1, False, True, etc.). At least one cell of the state map, when initially established in the database during state backup configuration process 206, may include at least one null value for at least one index of the performance.

Using at least one index of performance, the service contract metadata (e.g., 202) may also include at least one threshold that utilizes the at least one index of the performance. The at least one threshold may determine a measure of success of the service. For example, the service contract metadata (e.g., 202) may define a service that includes five operations. The five operations may be performed over one period of time. Over the one period of the time and/or for each operation of the five operations, five indices of the performance may be written to a state map.

After a service has been performed (i.e., after the five operations have been performed), the five indices of the performance may be written to the state map. If all of the indices of the performance are written as, for example, Is, Trues, etc., then the at least one threshold may be used to describe performance of the service as, for example, complete success. Instead, if all of the indices of the performance are written as, for example, 0 s, Falses, etc., then the at least one threshold may describe the performance of the service as, for example, complete failure. In a more complex case, if two of the indices of the performance are written as, for example, 0 s, Falses, etc. and three of the indices of the performance are written as, for example, 1 s, Trues, etc., then the at least one threshold may describe the performance of the service as, for example, low success.

Thus, via the interaction illustrated in FIG. 2A, a system in accordance with an embodiment may establish the functionality definition. Consequently, a deployment (e.g., 100) may be more likely to be able to provide desired computer implemented services by defining a service state layout (e.g., 208) for writing the at least one index of the performance for the at least one operation of the instance of the service.

Turning to FIG. 2B, a second data flow diagram in accordance with an embodiment is shown. The second data flow diagram may illustrate data used in and data processing performed in identifying an index of performance of at least one operation.

To identify an index of performance of the at least one operation, state identification process 214 may be performed. During state identification process 214, a schema (e.g., 210) and/or a state update event (e.g., 212) may be ingested. The schema (e.g., 210) may be similar to a second schema (e.g., 204) from the description of FIG. 2A.

The state update event (e.g., 212) may include a request for at least one performance metric of the at least one operation of a service on a first data processing system (e.g., 100A). The request may be made by a second data processing system (e.g., 100B), the service, etc.

If the second data processing system (e.g., 100B) makes the request, the request may be made when some period of time has elapsed, when a function call by a second service of the second data processing system (e.g., 100B) has been performed, etc. On the other hand, if the service has made the request, then the request may be made after the at least one operation has been completed by the service.

For example, the request may include a pull (e.g., the second data processing system (e.g., 100B) makes a request of the service for a transmission of data) and/or a push (e.g., an event process of the service occurs in which the service transmits the data). The data may include the at least one performance metric of the at least one operation. The at least one performance metric may include a data output, response time, success rate, throughput, resource utilization, etc. of the at least one operation. The at least one performance metric may be used to compute an index of the performance. The at least one performance metric may be transmitted by sending, by the service, the at least one performance metric of the at least one operation for at least one period of the time to a second service, a second data processing system (e.g., 100B, etc.), etc.

An index of the performance may be generated by the second service, a second data processing system (e.g., 100B, etc.), etc. The index of performance may be generated by performing at least one computation with the at least one performance metric. The at least one computation may evaluate a performance of the at least one operation using the at least one performance metric. The index of the performance may indicate, for example, normal behavior (e.g., 1) and/or at least one failure (e.g., 0) of the at least one operation.

As an example, in an instance of a service, a first operation may generate a random integer and a second operation may ingest the random integer from the first operation. The second operation may ingest the random integer and may allocate a measure of memory, to a third service, a third data processing system (e.g., 100C), etc., based on a value of the integer. For example, if the second operation ingests the integer (e.g., 100), then the second operation may allocate the measure of the memory (e.g., 100 megabytes). The second operation may be a first attempt at dynamic resource allocation for the third service, the third data processing system (e.g., 100C), etc.

When the push and/or pull has been requested by the second data processing system (e.g., 100B), the second service, etc., a first output of the first operation and a second output of the second operation may be received by the second data processing system (e.g., 100B), the second service, etc. The second data processing system (e.g., 100B), the second service, etc. may input the first output and/or the second output into at least one computation and may compute respectively a first index of performance of the first operation and/or a second index of performance of the second operation.

To compute the first index of the performance, the second data processing system (e.g., 100B), the second service, etc. may verify a quality of the first output. The first output may include an integer. Thus, the second data processing system (e.g., 100B), the second service, etc. may determine that the first operation exhibited normal behavior. Therefore, the second data processing system (e.g., 100B), the second service, etc. may assign the first index of the performance to be 1.

To compute the second index of the performance, the second data processing system (e.g., 100B), the second service, etc. may verify a second quality of the second output. The second output may include a NaN (e.g., not a number). Thus, the second data processing system (e.g., 100B), the second service, etc. may determine that the second operation exhibited at least one failure. Therefore, the second data processing system (e.g., 100B), the second service, etc. may assign the second index of the performance to be 0.

During state identification process 214, new state map data (e.g., 216) may include at least one index the performance state of the at least one operation. The new state map data (e.g., 216) may be reported to a management system (e.g., 104), a fourth data processing system (e.g., 100D), etc. and may be written to a state map of a service state layout (e.g., 208). The new state map data (e.g., 216) may be reported by sending, using a communication protocol, the new state map data (e.g., 216) to the management system (e.g., 104), the fourth data processing system (e.g., 100D), etc.

Thus, via the interaction illustrated in FIG. 2B, a system in accordance with an embodiment may identify the performance state of the at least one operation. Consequently, a deployment (e.g., 100) may be more likely to be able to provide desired computer implemented services by keeping a record of the performance of the at least one operation.

Turning to FIG. 2C, a third data flow diagram in accordance with an embodiment is shown. The third data flow diagram may illustrate data used in and data processing performed in generating a remediation plan.

To generate a remediation plan, issue management process 230 may be performed. To perform issue management process 230, service log data (e.g., 222), service state map data (e.g. 226) and an issue occurrence event (e.g., 228) may be ingested.

The service log data (e.g. 222) may be stored in a service log repository (e.g., 220). The service log repository (e.g., 220) may be stored, for example, in a management system (e.g., 104), a fourth data processing system (e.g., 100D), etc. The service log data (e.g., 222) may include at least one statement of at least one event occurring in an at least one operation of an instance of a service. The at least one statement may include (i) a timestamp (e.g., a date and/or a time), (ii) an operation identification (e.g., a unique identifier for the statement), (iii) the statement (e.g. an description of the event occurring in the at least one operation), (iv) a status (e.g., informational, debug, error, warning, etc.).

The service state map data (e.g., 226) may be stored in a service state map repository (e.g., 224). The service state map data (e.g., 226) may be stored after at least a portion of a state map has been populated during state identification process (e.g., 214) and/or the instance of the service has completed the at least one operation. The service state map data (e.g., 226) was described as a component of a service state layout (e.g. 208) from the description of FIG. 2A. Further, population of the service state map data (e.g., 226) with new state map data (e.g., 216) with at least one index of performance (e.g., 0, 1, etc.) was detailed in the description of FIG. 2B.

The issue occurrence event (e.g. 228) may include a review of the portion of the state map of the service state map data (e.g., 226). The review may give a summary of at least one failure on the state map (e.g., index=0) for the at least one operation during at least one period of time. The review may be transmitted to a logging framework, at least one administrator, etc. for development of a remediation plan (e.g., 232).

During issue management process 230, the logging framework, the at least one administrator, etc., to develop the remediation plan (e.g., 232), may access the service state map data (e.g., 226). The service state map data (e.g., 226) may be accessed to pinpoint at least one logical source of the at least one failure of the at least one operation within the at least one period of the time. Once the at least one logical source of the at least one failure has been pinpointed, at least one log may be used to further pinpoint context of the at least one failure. The at least one log may be used by ingesting at least one statement (e.g., informational, debug, error, warning, etc.) of the at least one log from the service log data (e.g., 222).

Afterwards, the remediation plan (e.g., 232) to restore functionality of the at least one operation of the service may be determined. The remediation plan may include (i) restarting the service, (ii) reverting code of the at least one operation to a stable version, (iii) applying at least one patch to the at least one operation, (iv) increasing resources available to the at least one operation, (v) reconfiguring a network setting and/or path, (vi) clearing a cache to remove outdated data, (vii) performing, by at least one administrator, an intervention to directly address the at least one failure, etc.

Continuing with the example from the description of FIG. 2B, the issue occurrence event (e.g., 228) may report that a second operation of the instance of the service included an index of performance with a value of 0, which indicates the at least one failure by the second operation. The issue occurrence event (e.g., 288) may be transmitted to the logging framework, the at least one administrator, etc. for generation of the remediation plan.

The logging framework, the at least one administrator, etc. may review the service state map data (e.g., 226). From the service state map data (e.g., 226), the logging framework, the at least one administrator, etc. may see that (i) a first value of 1 was generated for the first index of the performance for the first operation and (ii) a second value of 0 was generated for the second index of the performance for the second operation. Therefore, the logging framework, the at least one administrator, etc. may find that the first operation performed without failure and/or the second operation performed with the at least one failure.

To further pinpoint at least one source of the at least one error, the logging framework, the at least one administrator, etc. may review the at least one log from the service log data (e.g., 222). The logging framework, the at least one administrator, etc. may find at least one error statement (e.g., “input integer less than 0,” “memory allocation exceeded,” etc.). The logging framework, the at least one administrator, etc. may determine that (i) a first output generated from the first operation and/or ingested by the second operation cannot be used to generate a valid value of memory for a third service, a third data processing system (e.g., 100C), etc.

Therefore, the logging framework, the at least one administrator, etc. may generate the remediation plan (e.g., 232). The remediation plan (e.g., 232) may include, for example, (i) adding a zeroth operation to be performed before the first operation, (ii) mandating that the random integer that is (a) less than zero and/or (b) greater than a maximum value. The zeroth operation may include performing a query of the third service, the third data processing system (e.g., 100C), etc. to determine a measure of available memory. Based on the measure of the available memory, the maximum value may be defined. Therefore, the zeroth operation may have a zeroth output that includes the maximum value. Further, the first operation may be modified to ingest the maximum value.

Thus, via the interaction illustrated in FIG. 2C, a system in accordance with an embodiment may generate the remediation plan (e.g., 232). Consequently, a deployment (e.g., 100) may be more likely to be able to provide desired computer implemented services by using the service state map data (e.g., 226) and/or the service log data (e.g., 222) to pinpoint at least one source of error and, based on the pinpointing, improve the at least one operation of the instance of the service.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage operation of a deployment. FIG. 3 illustrates a method that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing operation of a deployment in accordance with an embodiment is shown. The method may be performed, for example, by any of the components of the system of FIG. 1, and/or other components not shown therein.

At operation 300, an occurrence of an issue impacting an ability of the deployment to provide computer implemented services may be identified. The occurrence may be identified by monitoring the deployment, receiving at least one notification from the deployment, receiving user feedback concerning the deployment, detecting, using a machine learning model, an anomaly of the deployment, etc.

At operation 302, obtaining, based on the identifying, at least one log of operation of a service hosted by the deployment that contributes to the computer implemented services. The at least one log of operation of a service may be obtained by retrieving, from a first repository, using a logging framework, an at least one administrator, etc. the at least one log.

At operation 304, a state map may be obtained for the service that indicates operational states of functionalities of the service over time. The state map may be obtained by retrieving, from a second repository, using the logging framework, the at least one administrator, etc. the state map.

At operation 306, a remediation plan may be obtained based on the at least one log and the state map. The remediation plan may be obtained by (i) identifying a point in time using the at least one log; and (ii) identifying a portion of the state map based on the point in time.

The point in time may be identified using the at least one log by reading, from the at least one log, at least one timestamp. The portion of the state map may be identified by correlating the point in time to at least one index of performance (e.g., 0, 1, etc.) of the at least one operation on the state map.

At operation 308, the remediation plan may be performed to update operation of the deployment to obtain an updated deployment. The remediation plan may be performed by performing at least one action (e.g., modifying code of the at least one operation, restarting the service, reverting code of the at least one operation to a stable version, applying at least one patch to the at least one operation, etc.) with the service to restore functionality of the service.

At operation 310, the computer implemented services may be provided using the updated deployment. The computer implemented services may be provided by instantiating a second instance of the service, the functionality of the service having been restored using the remediation plan, and performing at least one operation of the second instance. The method may end following operation 310.

Thus, via the method shown in FIG. 3, embodiments herein may likely improve a likelihood of managing operation of a deployment. By improving the likelihood of managing operation of a data processing system, the data processing system may be more likely to provide desirable computer implemented services by, for example, recording the functionality of the at least one operation of the service using a value of the index of the performance on the state map, using the at least one log and the state map to pinpoint at least one source of error in the at least one operation of the service, etc.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a deployment, the method comprising:
identifying an occurrence of an issue impacting an ability of the deployment to provide computer implemented services;
based on the identifying of the occurrence:
obtaining at least one log of operation of a service hosted by the deployment that contributes to the computer implemented services;
obtaining a state map for the service that indicates operational states of functionalities of the service over time;
obtaining a remediation plan based on the at least one log and the state map;
performing the remediation plan to update operation of the deployment to obtain an updated deployment; and
providing the computer implemented services using the updated deployment.

2. The method of claim 1, wherein the state map is part of a state definition for a service.

3. The method of claim 2, wherein the state definition comprises:
an identification of the service;
at least one instance of the service;
a functionality definition for the service;
at least one threshold that describes a measure of success of at least one service;
the state map; and
a backup of the state map.

4. The method of claim 3, wherein the functionality definition indicates whether each function of the service is operable or inoperable.

5. The method of claim 4, wherein the functionality definition is usable to define portions of the state map at different points in time.

6. The method of claim 5, wherein each of the portions of the state map corresponds to different points in time, and each of the portions comprises:
a listing of indications of operability of functions of the service, and
an indication of a corresponding one of the different points in time.

7. The method of claim 1, wherein obtaining the remediation plan comprises:
identifying a point in time using the at least one log; and
identifying a portion of the state map based on the point in time.

8. The method of claim 7, wherein the portion of the state map indicates operability of functions of the service during the point in time.

9. A non-transitory machine-readable medium having instructions stored therein, which when executed by a processor, cause the processor to perform operations for managing operation of a deployment, the operations comprising:
identifying an occurrence of an issue impacting an ability of the deployment to provide computer implemented services;
based on the identifying of the occurrence:
obtaining at least one log of operation of a service hosted by the deployment that contributes to the computer implemented services;
obtaining a state map for the service that indicates operational states of functionalities of the service over time;
obtaining a remediation plan based on the at least one log and the state map;
performing the remediation plan to update operation of the deployment to obtain an updated deployment; and
providing the computer implemented services using the updated deployment.

10. The non-transitory machine-readable medium of claim 9, wherein the state map is part of a state definition for a service.

11. The non-transitory machine-readable medium of claim 10, wherein the state definition comprises:
an identifier of the service;
a functionality definition for the service;
the state map; and
a backup of the state map.

12. The non-transitory machine-readable medium of claim 11, wherein the functionality definition indicates whether each function of the service is operable or inoperable.

13. The non-transitory machine-readable medium of claim 12, wherein the functionality definition is usable to define portions of the state map at different points in time.

14. The non-transitory machine-readable medium of claim 13, wherein each of the portions of the state map corresponds to different points in time, and each of the portions comprises:
a listing of indications of operability of functions of the service, and
an indication of a corresponding one of the different points in time.

15. A data processing system, comprising:
a processor; and
a memory coupled to the processor to store instructions, which when executed by the processor, cause the processor to perform operations managing operation of a deployment, the operations comprising:
identifying an occurrence of an issue impacting an ability of the deployment to provide computer implemented services;
based on the identifying of the occurrence:
obtaining at least one log of operation of a service hosted by the deployment that contributes to the computer implemented services;
obtaining a state map for the service that indicates operational states of functionalities of the service over time;
obtaining a remediation plan based on the at least one log and the state map;
performing the remediation plan to update operation of the deployment to obtain an updated deployment; and
providing the computer implemented services using the updated deployment.

16. The data processing system of claim 15, wherein the state map is part of a state definition for a service.

17. The data processing system of claim 16, wherein the state definition comprises:
an identifier of the service;
a functionality definition for the service;
the state map; and
a backup of the state map.

18. The data processing system of claim 17, wherein the functionality definition indicates whether each function of the service is operable or inoperable.

19. The data processing system of claim 18, wherein the functionality definition is usable to define portions of the state map at different points in time.

20. The data processing system of claim 19, wherein each of the portions of the state map corresponds to different points in time, and each of the portions comprises:
a listing of indications of operability of functions of the service, and
an indication of a corresponding one of the different points in time.
